(19) United States
(12) Patent Application Publication
(10) Pub. No.: US 2020/0113755 A1
(43) Pub. Date: Apr. 16, 2020

(54) AUTOMATED MOBILITY DEVICE AND VEHICLE INTERFACE

(71) Applicant: Honda Motor Co., Ltd., Tokyo (JP)

(72) Inventors: Shigeyuki SEKO, Campbell, CA (US); Shinichi AKAMA, Cupertino, CA (US); Brian W. JOHNSON, SAN FRANCISCO, CA (US)

(21) Appl. No.: 16/156,070

(22) Filed: Oct. 10, 2018

(51) Int. Cl. A61G 5/04; H04M 1/725; G05D 1/00; G05D 1/02

(52) U.S. Cl. CPC A61G 5/04; H04M 1/7253; G05D 1/0088; A61G 2203/30; A61G 2203/22; A61G 2203/20; G05D 1/0231

(57) ABSTRACT

The systems and methods provided herein are directed to navigating an automated mobility device for docking and undocking with a vehicle. The position and orientation of the mobility device relative to the vehicle are determined based on real-time images of the vehicle. Based on the position and orientation of the mobility device, the system determines a control command for automatically navigating the mobility device from its determined position to a docking position within the vehicle. The system subsequently determines a control command for automatically navigating the mobility device from the docking position within the vehicle to a position outside the vehicle.

### BACKGROUND

A range of innovations exist to accommodate users with limited mobility in operating a motor vehicle. Mobility devices, such as manual or motorized wheelchairs can be lifted into motor vehicles and locked in place of vehicle seats, and automated accessibility features increase the ease with which mobility devices can be brought into vehicles.

### BRIEF DESCRIPTION

According to one exemplary embodiment, a computer-implemented method to automatically navigate a mobility device includes receiving real-time images of a vehicle; determining the position and orientation of a mobility device relative to the vehicle based on the received real-time images; automatically determining, based on the position and orientation of the mobility device, a control command for navigating the mobility device from its determined position to a destination position within the vehicle; and providing the determined control command to cause the mobility device to move.

In some embodiments, the method can include repeating steps until the mobility device's position is determined to be the destination position.

In some embodiments, the destination position can be a docking position. The method can also include determining that the mobility device is positioned at the docking position and automatically activating a mechanical locking system in order to lock the mobility device in the docking position within the vehicle. The method can also include automatically activating an electrical connection between the mobility device and the vehicle.

In some embodiments, the vehicle can include an integrated accessibility feature such that the determined position of a vehicle is outside the vehicle and the mobility device is automatically navigated into the vehicle using the integrated accessibility feature. The accessibility feature can be a deployable ramp.

In some embodiments, real-time images can be received from a camera mounted on the mobility device or from a mobile device.

The steps can be performed by a mobility device controller in response to receiving a user-initiated instruction from a mobile device. The mobility device controller can further receive from the mobile device a user-initiated instruction and provide a control command to cause the mobility device to stop moving.

According to one exemplary embodiment, a computer-implemented method to automatically accommodate a mobility device comprises receiving, at a control system associated with a vehicle, a signal from a mobility device outside the vehicle; determining one or more vehicle operations necessary to configure the vehicle for automated docking by the mobility device; executing the determined one or more vehicle operations on the associated vehicle; subsequent to executing the determined one or more vehicle operations, determining a position of the mobility device within the vehicle; and based on the mobility device's position within the vehicle, executing one or more further vehicle operations to accommodate the mobility device.

In some embodiments, the mobility device can be a wheelchair. The vehicle operations can include deploying a motorized ramp. The further vehicle operations can include automatically activating a mechanical locking system to secure the mobility device within the vehicle.

In some embodiments, the vehicle operations can be based on a determined position of the mobility device outside the vehicle.

According to one exemplary embodiment, an automated mobility device includes an arm configured to receive a mobile device and a controller that can electronically connect to a mobile device received by the arm. Based on receiving a signal from the mobile device, the controller can provide a control command to cause the mobility device to move.

In some embodiments, the controller determines the position and orientation of the mobility device relative to a vehicle, and then automatically determines the provided control command based on the mobility device's position and orientation. The provided control command is for navigating the mobility device from its determines position to a destination position.

In some embodiments, the controller receives a second signal from the mobile device and provides a control command to cause the mobility device to stop moving. Both signals from the mobile device can be sent in response to commands initiated by a user interacting with the mobile device.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective view of an automated wheelchair in accordance with one aspect of the present disclosure;

FIG. 2 is a rear perspective view of the automated wheelchair of FIG. 1 in accordance with one aspect of the present disclosure;

FIG. 3 is a device schematic of an automated wheelchair in communication with a mobile device in accordance with one aspect of the present disclosure;

FIGS. 4A-4F illustrate screens of a mobile application for controlling an automated wheelchair with one aspect of the present disclosure;

FIG. 5 is side view of a vehicle in accordance with one aspect of the present disclosure;

FIGS. 6A and 6B are top-down map views of a vehicle with a marked navigation route for a wheelchair in accordance with one aspect of the present disclosure;

FIG. 7 is an illustration of an interior vehicle with a wheelchair positioned therein, in accordance with one aspect of the present disclosure;

FIG. 8 is a flow diagram illustrating an exemplary method for navigating a wheelchair to enter into and dock with a vehicle in accordance with one aspect of the present disclosure; and

FIG. 9 is a flow diagram illustrating an exemplary method for navigating a wheelchair to undock and egress from a vehicle in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure can be constructed and/or utilized. The description sets forth the functions and the sequence of blocks for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the systems and methods herein are directed to an automated process for positioning and docking a motorized wheelchair within a motor vehicle. Visual data is used to automatically position and navigate the wheelchair into and within the vehicle without detailed input from the user.

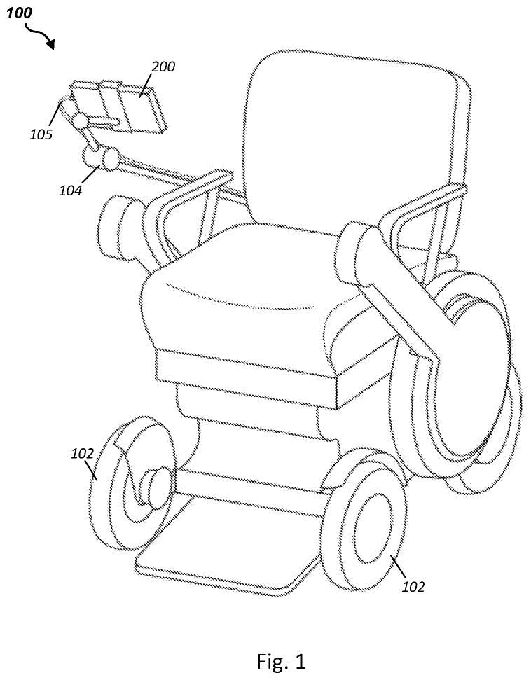

FIG. 1 shows a motorized wheelchair 100 as an example of a mobility device configured for use with an embodiment of the present disclosure. The wheelchair 100 includes wheels 102 that are motorized and controlled as described herein. A movable arm 104 extends from the chair and can be easily positioned so that the end of the arm 104 is within easy view and reach of the chair's user.

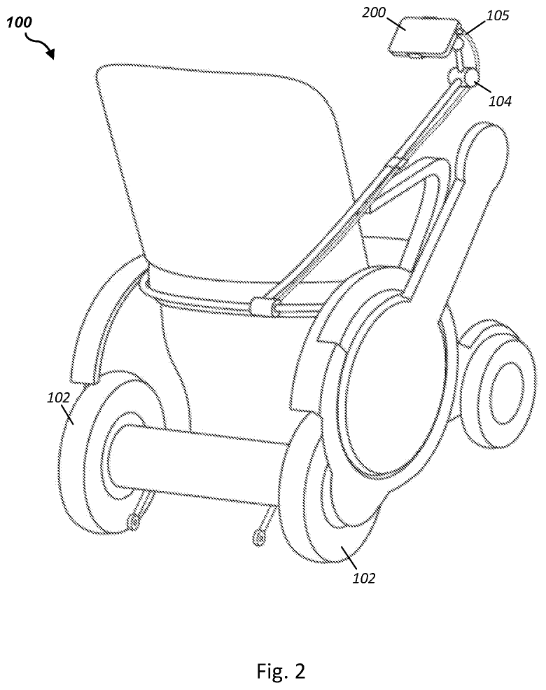

As shown also in FIG. 2, the arm 104 is, in some implementations, configured to hold a device 200 to interface for the wheelchair 100. The arm 104 may be specifically sized and suited for holding a particular device, such as a mobile device 200 as herein described, and in some implementations, a different arm component may be installed depending on the particular device to be used. The arm 104 may be an adjustable clamp, tray, or other mechanism that can receive a plurality of devices. In some implementations, a dedicated device that is suited to stay connected to the arm 104 may be included. In other implementations, the arm 104 may be configured to accommodate a user's smart phone, tablet, or other mobile device.

Some implementations of the arm 104 may include a cord interface 105 that connects to the mobile device 200. This cord interface 105 may, in some implementations, allow for communication between a wheelchair controller 120 (further described below) and the connected device 200. The cord interface 105 may, in some implementations, provide power to the connected device 200 from a wheelchair battery 106 (further described below) or other power source. One of ordinary skill in the art will recognize that a cord interface 105 may provide only communication, only power, or both communication and power. In some implementations, one or more ports, such as a USB port (not shown), may be provided in the arm such that different cords configured for different devices can be connected.

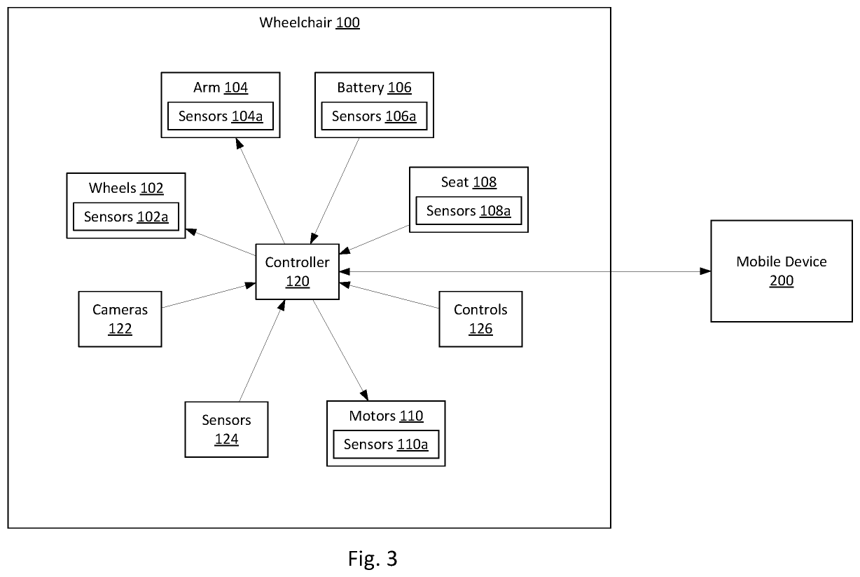

FIG. 3 is a schematic diagram showing the components of a motorized wheelchair 100 configured to interface with a vehicle as described herein. A controller 120 receives input from cameras 122a,b, feedback sensors 124, and a mobile device 200 connected thereto.

In one implementation, cameras 122a,b may be mounted on the chassis of the wheelchair 100 and positioned to provide front and rear views of the area surrounding the chair. The cameras may be stationary relative to their position on the chair or may include articulated mounts that allow them to move as needed. In some implementations, the front camera 122a may be mounted on the arm.

A different number or positioning of cameras may be used in different implementations. For example, a single camera may be used, or more than two cameras may be used. Data from cameras not integrated with the wheelchair 100 may be used in addition to or instead of the cameras 122a,b, such as the cameras of one or more mobile devices, cameras associated with the vehicle within which the wheelchair can automatically navigate as described herein, stationary indoor or outdoor cameras associated with a residence, business, or garage, or any other available cameras for which the controller 120 can receive input.

Feedback sensors 124 may include any sensors disposed on or near the wheelchair in order to sense the position, orientation, speed, acceleration, or status of the wheelchair and its components. Mechanical or digital gyro systems may be included to monitor stability of the wheelchair. Wheel motors 102 may include sensors 102a that provide information regarding the orientation and motion of the wheels. The movable arm 104 may include sensors 104a that convey information regarding the position and motions of the arm 104, including sensor data on objects held by the arm 104 or connected to the interface 105. A wheelchair battery 106 may include sensors 106a that convey information regarding the battery operation, such as its remaining capacitance and rate of discharge.

In some implementations, the wheelchair seat 108 may include a variety of sensors 108a for monitoring the occupant of the wheelchair. These may include pressure or contact sensors to determine when the seat is occupied. In some implementations, seat sensors 108a may be configured to determine the occupant's posture within the seat (for example, resting against the back of the seat or leaning forward). In some implementations, the controller 120 may provide commands to components of the wheelchair 100, or may provide notifications to a connected mobile device 200, based on receiving data from seat sensors 108a that the controller 120 identifies as movement of the occupant. For example, the controller 120 may identify sensor data with the occupant attempting to get up from the wheelchair 100 and may maneuver the wheelchair 100 to accommodate the occupant's action. The seat 108 may also include sensors 108a that measure the user's biometric data such as breathing, temperature, or heart rate. In some implementations, seat sensors 108a may allow the controller 120 to identify a known user and associate that user with a known preference and/or health profile.

In some implementations, the wheelchair 100 may include component motors 110 which allow for powered adjustments for components of the wheelchair. Any or all of the armrests, seat 108, back, wheels 102, movable arm 104, or any other adjustable component may be equipped with automated motion in some embodiments. The component motors 110 may provide, for example, increased accessibility for the wheelchair occupant by allowing the features to accommodate different configurations for entering and exiting the wheelchair 100, and to increase the range of motions available to the occupant while seated in the chair 100. One or more of the component motors 110 may, in some implementations, include sensors 110a that send data to the controller 120 indicating the position of the motor and/or the component moved by that motor. The component motors 110 may draw power from the wheelchair battery 106 or may be separately powered.

In some implementations, the components of the wheelchair 100 may be modular. One or more components may be attachable or detachable from the wheelchair 100 to allow the system to be used in different configurations. For example, the movable arm 104 may be removable. A table, tray, or basket component may replace the arm 104 for some occupants or in some situations. The seat 106 may be removable so that a seat of a different size or shape may be substituted to better fit an occupant. The wheels 102 may be replaceable to better navigate an intended environment, such as an indoor domestic setting or an outdoor public setting. Some modular components may include circuitry in order to electrically connect to the controller 120 and provide relevant data regarding the component and its functions. A modular component may be powered and may include an integrated power source or may be configured to connect to the wheelchair battery 106. A modular component may include a wireless receiver and/or transmitter in order to communicate with the controller 120 without the requirement of an electrical connection.

In some implementations, the controller 120 receives input from a mobile device 200. Input may include commands issued by a user by interacting with the mobile device 200. The user interacting with the mobile device 200 may occupy the mobility device; in some implementations, the user may also be a different person than the occupant of the mobility device. The mobile device 200 may be any wirelessly-enabled computer device as known in the art. For example, in some implementations, a laptop computer, a tablet computer, a smartphone, a wearable computer, a special-purpose chipset, a transmission fob, or any other device having the capabilities attributed in this disclosure may be understood as a mobile device as described herein.

The controller 120 may provide signals to a variety of wheelchair components including, for example, the wheels 102, arm 104, and component motors 110. The controller may further provide signals and data to the mobile device 200 and any other device connected thereto. Implementations may include wireless connections, wired connections, or both.

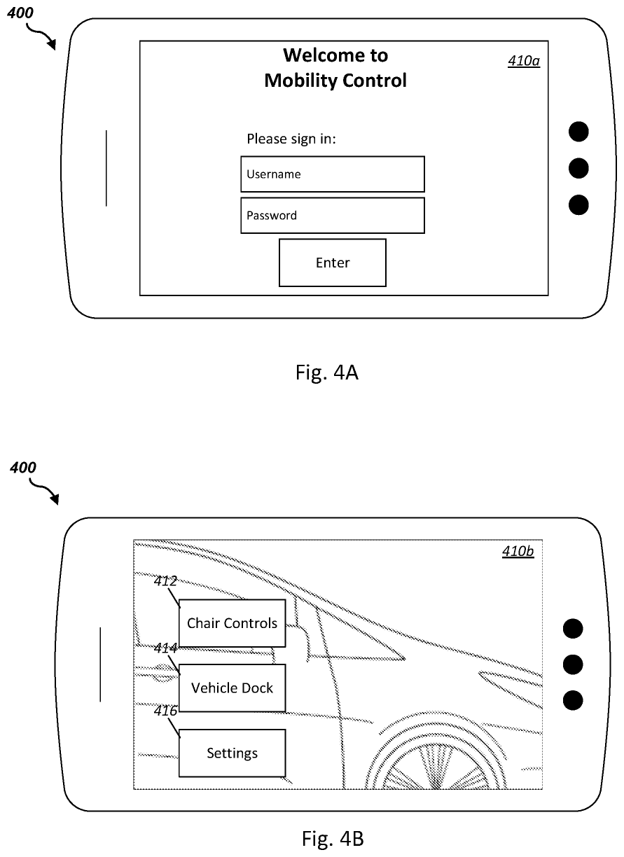

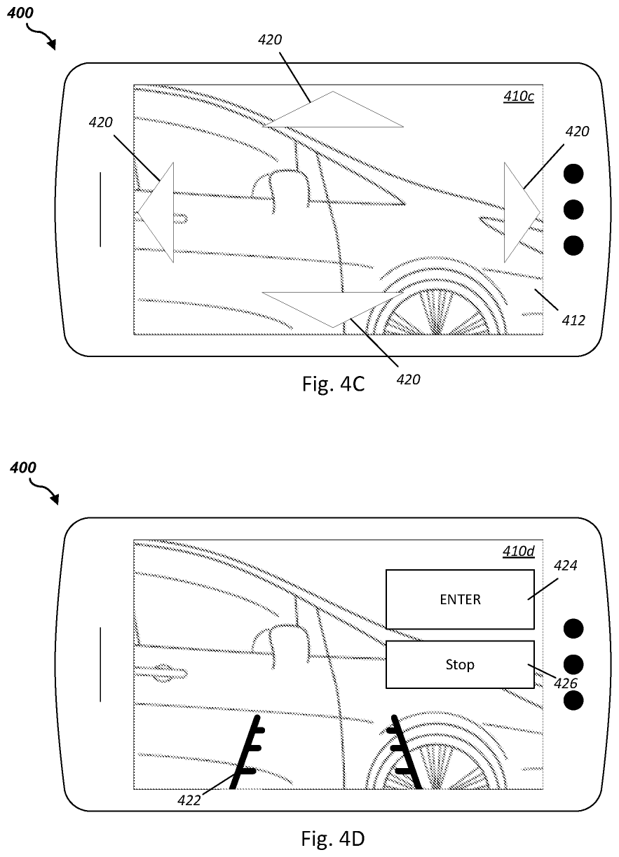

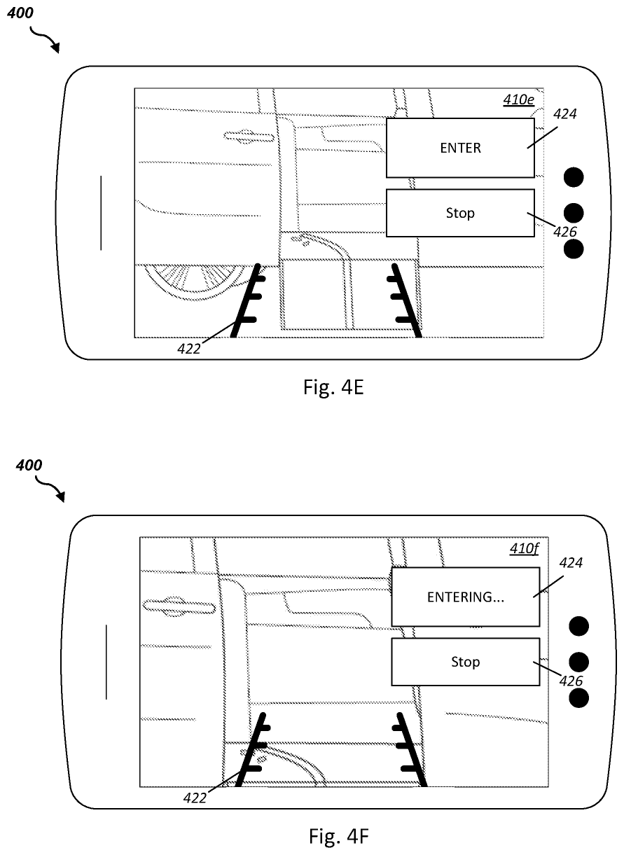

As shown in FIGS. 4A-4F, a mobile device 400 may in some implementations include an interface, mobile site, or application for control of an automated mobility device. A first screen 410a of an exemplary application is illustrated in FIG. 4A, wherein a user may sign in with credentials to access the application and control of the mobility device. In some implementations, credentials may be supplied by alternate methods, such as credential management features of the mobile device 400 or features associated with the mobility device. For example, an initial exchange of credentials between a wheelchair controller 120 and mobile device 400 may subsequently pair the devices such that subsequent connections of the mobile device 400 to the mobility device may not require re-submission of the credentials. In some implementations, a Guest mode may be available to allow a user limited control of the mobility device without signing in. The initial exchange of credentials or any subsequent exchange, may be conducted over a wired interface such as the cord interface 105 illustrated above, or over any appropriate wireless interface known in the art. A short-wave radio protocol such as BLUETOOTH® or wireless interface such as WiFi may be used to carry out wireless communication between the mobile device 400 and controller 120.

FIG. 4B shows an application screen 410b with different buttons comprising a main menu for operation of the mobility device. As illustrated, the user may select a first button 412 to access a control panel for the mobility device (FIG. 4C), a second button 414 to access a vehicle docking interface (FIG. 4D), or a third button 416 to access a settings menu.

The application screen 410b may further include one or more video images representing an image from any available camera as described above. In some implementations, application screens 410 may include by default images taken from a camera associated with a mobile device 400. As further described below, the display may include the one or more images that are most relevant to the operation of the mobility device.

FIG. 4C shows an illustrative example of a control panel application screen 410c which can allow a user to input manual commands for movement of the mobility device. In some implementations, touching one of the navigation buttons 420 may transmit an instruction to the controller 120 to control the wheels 106 to move forward, turn, or move in reverse depending on the button pressed. In some implementations, the display image associated with the application screen 410c may be from the front mounted camera 122a normally but may switch to the rear mounted camera 122b when the user has instructed the mobility device to travel in reverse. In some implementations, the user may be able to select between multiple camera views or configure which camera view will accompany different control operations. In some implementations, the control panel 412 may be programmable such that a variety of instructions may be bound to buttons disposed on the screen 410 in a configuration selected by the user. Multiple screens of buttons may be saved to be selected between and associated with the user's profile in some implementations.

FIGS. 4D, 4E, and 4F show an illustrative example of application screens 410d-f for activating an automated feature wherein the mobility device navigates into and docks within a vehicle. As shown, when on the docking application screens 410d-f, a guide graphic 422 may be superimposed on an image of the surroundings which may, for example, show the expected path of the mobility device should the device be operated in that direction without any additional turning. The guide graphic 422 may, in some implementation, include multiple colors and/or hash marks to convey distances and ranges at which objects seen in the image may pose obstacles to the mobility device.

In some implementations, the automated docking feature may be limited such that it only operates when the mobility device is within a range of orientation and position that the controller 120 identifies as near the vehicle's accessible entrance. This may be assessed according to the camera image that is displayed on the application screen 410, which may be, for example, the rear mounted camera 122b. For example, in some implementations, a user selecting the automated docking button 424 when the application screen shows the front portion of the vehicle as in FIG. 4D may cause the controller 120 to refuse to begin automated docking. In this situation, the controller 120 may identify the mobility device as not being positioned near any accessible entrance, and therefore not within the range of locations for which the automated docking feature can be initiated. This may be indicated by the graphic associated with the button 424 being altered to convey to the user that the button is not currently selectable. The mobile device 400, and subsequently the user, may be notified of the failure by a warning screen or other notification as known in the art.

As shown in FIG. 4E wherein the background image of the application screen 410e shows the portion of the vehicle proximate the ramp, selecting the automated docking button 424 may begin an automated docking process as further described below. As shown in FIG. 4F, the docking button 424 may display that the vehicle is docking and, in some implementations, further selection of the button 424 during docking may have no effect. In contrast, the manual stop button 426 provided on the screen 410f may be selected by a user to halt the automated docking process during the procedure, which may result in the mobility device remaining stationary and waiting for further input or manual control from a user.

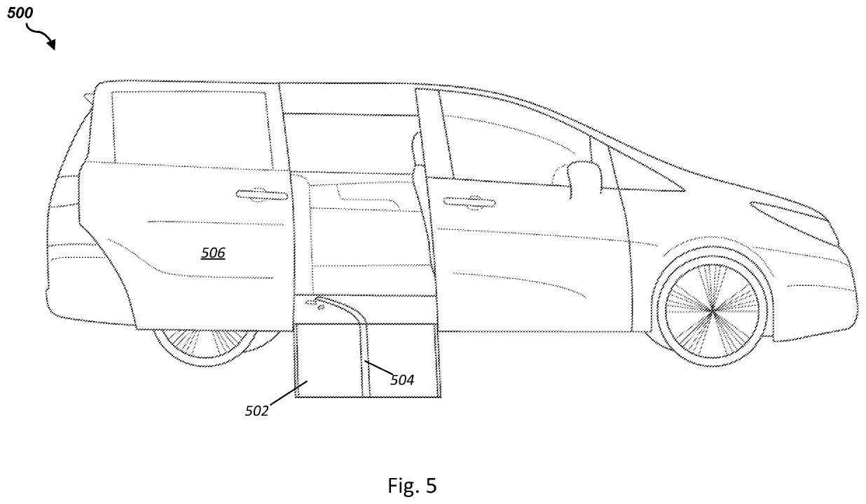

FIG. 5 shows a vehicle 500 which is configured to accept and dock the mobility device. The vehicle 500 includes an integrated accessibility feature, in this case a deployable access ramp 502. In some implementations, the deployable ramp 502 is motorized to deploy and retract automatically in order to accommodate the mobility device. In some implementations, the controller 120 may be paired (by BLUETOOTH®, WiFi or some other protocol) to wirelessly communicate with control systems associated with the vehicle 500, including issuing the instructions to open a vehicle door 506 and deploy the ramp 502. In some implementations, these functions may be carried out by a user using a different control mechanism or device, such as controls on the vehicle or a separate wireless control. In some implementations, a mobile device 400 may include features to control the vehicle 500 as well as the mobility device.

The vehicle 500 may include markings 504 that aid the mobility device in automated navigation and docking within the vehicle 500. A mobile device imaging system, such as the front and rear mounted cameras 122a,b described above, may be positioned such that they can follow the markings 504 as the mobility device navigates up the ramp 502, into the vehicle 500, and to a destination position 508 for docking. In some implementations, the markings 504 may be subtle to the user and integrated with the visual design of the vehicle 500. In some implementations, the markings 504 may be clear and stand out in order to maximize their visibility to the mobility device imaging system, as well as to mark the mobility device's docking path for the benefit of the user.

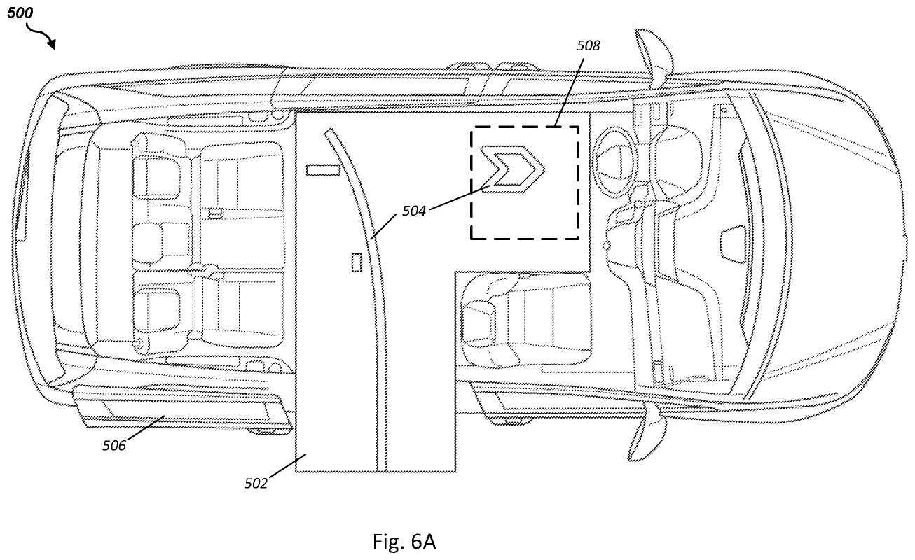

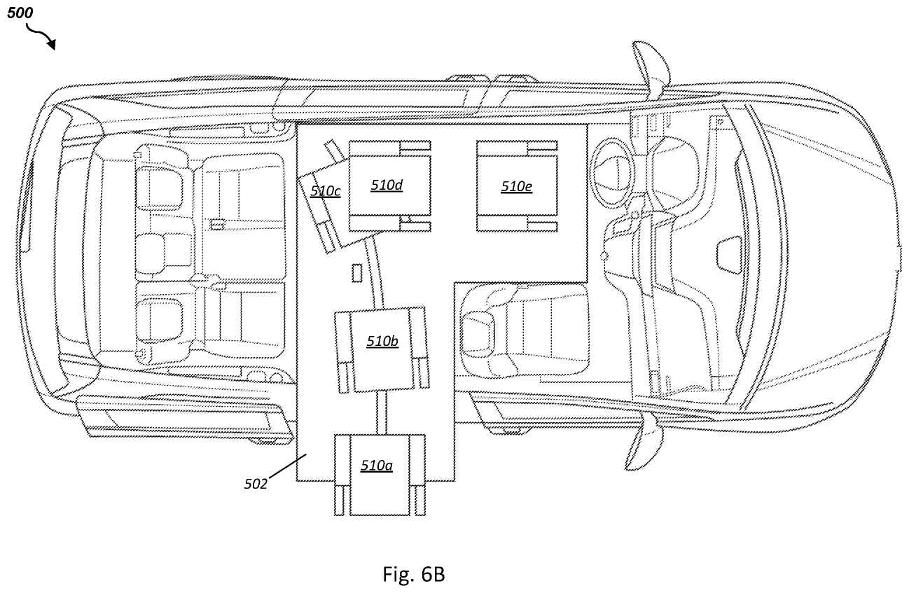

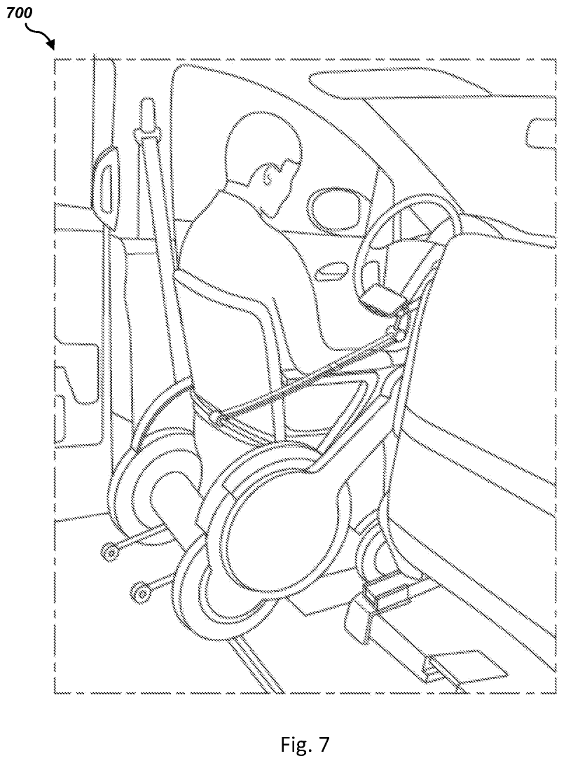

As shown in the top-down map views of FIGS. 6A and 6B, the vehicle 500 may include markings 504 from the ramp 502, into the interior, and to the docking position which may be a driver position. FIG. 6B illustrates multiple mobility device positions 510a-e which collectively illustrate a path for the mobility device to automatically navigate into the docking position. The mobility device begins facing away from the vehicle (510a), then backs up the ramp (510b) and into a corner (510c). The mobility device then turns and reverses direction (510d) and moves forward to arrive at its destination and docking position (510e). In some implementations, positions 510e-a taken in reverse illustrate a comparable path for egress from the vehicle 500, in which a mobility device moves backwards from its initial position (510e), reverses at the corner (510d and 510c), and then exits the vehicle facing forward (510b and 510a). FIG. 7 provides a view 700 of a docked mobility device with a passenger positioned for operating the vehicle.

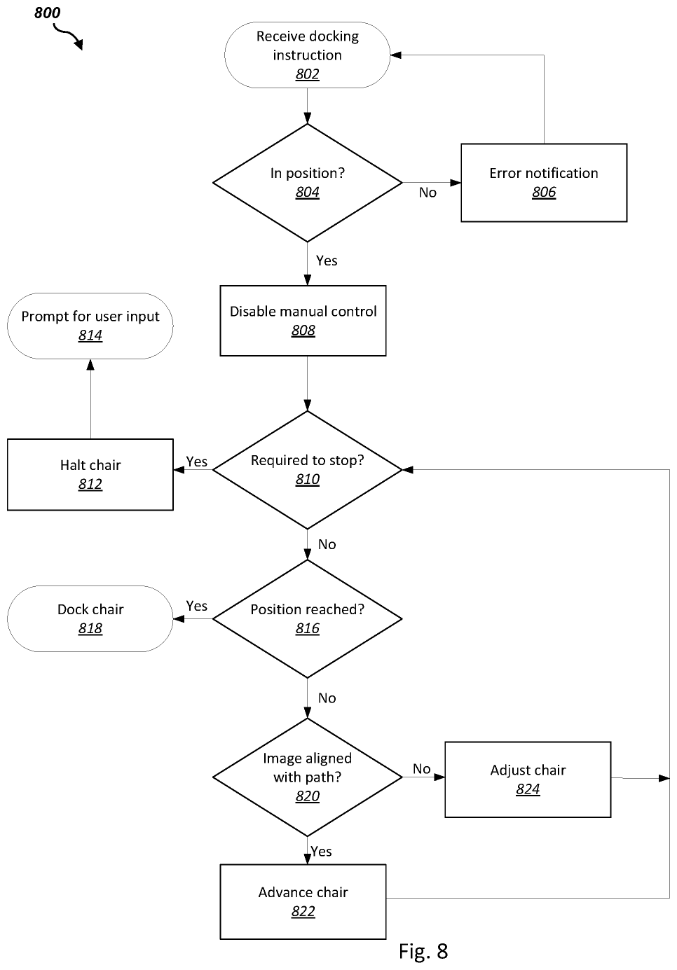

The flowchart in FIG. 8 illustrates a method 800 for automated navigation of a mobile device for docking within a vehicle. Although, as described above, these steps may be performed by a controller integrated with the mobile device, it will be understood that one or more of these steps may be carried out by other control mechanisms such as those associated with a mobile device or with one or more vehicle systems. One of ordinary skill in the art will recognize the coordination possible between different systems in digital communication.

The system receives a docking instruction from a user or from another system (step 802). In some implementations, the docking instruction may represent one or a small number of selections taken by a user on a mobile device (such as mobile device 200 or 400) or on controls for the motorized mobility device (such as the wheelchair 100). Imaging systems, which may retrieve images from any available imaging device (such as cameras 122a,b described above) within range of the mobility device 100 and/or vehicle (such that vehicle 500) in different embodiments, determine whether the mobility device 100 is within a range of positions and orientations to navigate the mobility device 100 into the vehicle 500 (step 804). If the system determines that the mobility device 100 is not in position, then an error notification is provided for use by any appropriate control system 120 and, in some implementations, reported to a user having selected the docking command (step 806).

In some implementations, the system may include a window of operation for the user to place the mobility device 100 in position following the selection and failure of the initial docking command. For example, the error notification given to the user may prompt the user to control the mobility device's position to line up the vehicle ramp (such as the ramp 502) in the image to guide lines or other markings (such as the guide markings 504) on the displayed screen (such as the mobile device screen 410). Should the user control the mobility device 100 to place it within an acceptable position before a certain window of time expires, then the system may automatically proceed to docking the mobility device 100 without requiring that the user select the docking instruction again.

In some implementations, the mobility device controller (such as the controller 120) may, in addition to confirming the position of the mobility device 100, also confirm the status of one or more vehicle features before initiating automated navigation. For example, the mobility device controller 120 may require communication from a control system associated with the vehicle 500 that the vehicle is in park or the engine is off, that seats are positioned such as to give the mobility device 100 proper clearance, that hazard lights or other accessibility features are activated, or any other vehicle-controlled feature necessary or preferred for navigation of the mobility device 100 onto the vehicle 500.

If the position of the mobility device 100 relative to the vehicle 500 allows the mobility device 100 to begin automatic navigation into the vehicle 500, then the system may disable manual control of the mobility device 100 during the automated navigation (808). In some implementations, manual control may be disabled by the mobility device controller 120 receiving control signals as normal but disregarding those control signals during this procedure. Control signals received from a remote source, such as from the chair controls application screen 410c, may also be disregarded during this procedure. In some implementations, a message may be displayed acknowledging that a control instruction was sent but noting that the automated navigation is underway.

Steps 810 through 824 form an illustrative control loop configured to continue to move the mobility device 100 to its docking position (such as the position 508) until that position is reached or until an exception ends the loop prematurely. While these steps are presented for illustrative purposes, it will be understood that other navigation steps and control methods may be used in different implementations. For example, markings 504 on a vehicle may act as sophisticated instructions for when and how much the mobility device 100 should turn at certain points along its path. Furthermore, the mobility device control system 120 may include preset instructions for known vehicles which include when and how much to turn at certain points of the navigation path. Other technologies related to real-time automated navigation, such as visual simultaneous localization and mapping (“VSLAM”) sensors, circuitry, and/or logic may be included to enable movement of the mobility device 100.

Each time the navigation procedure enters the control loop, the system checks for any exception requiring the procedure to stop (step 810). Any number of conditions may cause this determination. For example, as noted above with respect to the mobile device application screens 410, a stop button 426 may be included on some screens 410 that a user can select to halt the procedure. In some implementations, the mobility device 100 may include visual or other sensors (such as cameras 122a,b) that can detect an obstacle or person within the path of the mobility device 100, and may halt the procedure prior to reaching the obstacle. In some implementations, data from mobility device sensors associated with the position or condition of a passenger, such as that the passenger is not securely situated in the seat, may prompt a stop to the procedure.

If a stop requirement is determined, then the device 100 is controlled to safely halt (812). In some implementations, controlling the device 100 to halt may not always consist of stopping the device 100 at its current position. For instance, where the mobility device 100 determines it is required to stop on a location that is not statically stable such as an access ramp 502, the system may instead determine the closest appropriate location for a halt and may move the mobility device 100 to that location before stopping. The system may do so by, for example, maintaining a record of its inclination and the relative load on its motorized components at different locations along its path. A position (such as, for example the position 510a) with recorded inclination and load values below a threshold may then be selected and the mobility device 100 navigated to this position. As another example, where an obstruction has been detected along the route, the system may briefly navigate the mobility device 100 away from the obstruction to assure that the mobility device 100 is entirely clear of the obstruction.

Once the device 100 is halted, the system prompts the user for further input (step 814). In some implementations, such as where a temporary obstacle caused the system to halt, the prompt may include instructions to the user before the docking can resume. The system may wait on the user selecting an input signaling that the condition causing the system halt has been resolved.

Because in some implementations aborting the docking procedure may halt the mobility device 100 in a situation where navigation is dangerous or difficult, manual control may not be automatically returned to the mobility device 100 upon carrying out the halting command. Instead, a limited list of user input instructions such as finishing the loading procedure, making small adjustments to the mobility device 100, or reversing and unloading the mobility device 100 may be provided to the user. The user may, in some implementations, also have the capability of resuming full manual control accompanied by necessary warnings from the system.

At any cycle of the control loop in which a stop requirement is not determined, the system will check to see if the final position of the mobility device 100 has been reached (step 816). In some implementations, sensors (such as, for example, any of the sensors 102a-110a or 124) may be able to detect the proximity and alignment of docking features to confirm the destination position. Sensors in the vehicle 500 may also be able to send signals to the mobility device controller 120 to confirm the mobility device's position. Visual images, either in reference to vehicle markings 504 or not, may also be used to determine or confirm that the vehicle 500 is in its appropriate position. The mobility device's docking position may, in some implementations, be a vehicle driving position as described above and shown in FIG. 7. In some implementations, the vehicle 500 may be configured so that until the mobility device 100 is confirmed to be properly docked into the driver's position 508, the vehicle 500 will not start or will not shift into gear.

Once the mobility device 100 is found to be in position, it interfaces with the mobility device dock on the vehicle (step 818). In some implementations, mechanical locks may interface with the wheels and/or chassis to hold the device 100 securely in place during travel. Electrical components may also interface between the vehicle 500 and the device 100, so that, for example, the mobility device battery 106 can be charged by the vehicle electrical system. An electrical interface may also enable mobility device seat 108 and arm 104 adjustments to be powered through vehicle electricity rather than, or in addition to, the mobility device battery 106 while the device 100 is docked.

Docking of the mobility device 100 may, in different implementations, be manual or automatic to different extents. In one implementation, mechanical and electrical interfaces may be automated by the device 100 and/or the vehicle 500. Mechanical interfaces, may include, for example, a mechanical locking system that can be locked and/or unlocked automatically by the vehicle 500 and/or the mobility device controller 120. In another implementation, manual locking of the device 100 may be a required part of the docking procedure, and a manual cord may be connected and disconnected by a user for electrical power. Where one or more manual components are necessary, a mobility device display, vehicle display, or mobile device display may prompt a user to carry out the necessary steps.

Returning to the control loop, if the position 508 is not yet reached (“no” branch of decision block 816), then the current image or images of the mobility device's position within the vehicle 500 are processed to determine whether the devices's position continues to align with the path or whether the chair needs to turn (step 820). In some implementations, such as that showed in the top-down map of FIG. 6B, the standard position for the mobility device's navigation into the vehicle 500 may be in reverse. In this case, a rear mounted camera 122b on the mobility device 100 or another camera view may be used to confirm the alignment of the mobility device 100 for continuing to advance along the path.

If the device 100 is properly aligned, then the controller 120 advances the chair along the navigation path as appropriate (step 822). As mentioned above, what is referred to as advancing the device 100 may depend on the orientation of the device 100, and may involve reverse motion of the wheels 102 in embodiments where at least some of the automated navigation and docking procedure occurs in reverse.

If the device 100 is misaligned from the next leg of its navigation path, then the mobility device 100 is adjusted to orient in the correct direction (step 824). In some implementations, adjusting the chair may involve further proximity sensing to confirm that there is sufficient clearance in the area around it to rotate it. One of ordinary skill in the art will recognize that automated navigation around obstacles may include both translational and rotational movement until corrections are made. In some implementations, the wheels 102 of the mobility device 100 will not allow the device to rotate on the spot. Instead, the wheels 102 may only turn left or right as the device 100 moves forward or backward. The controller 120 can account for these limitations in navigating the mobility device 100.

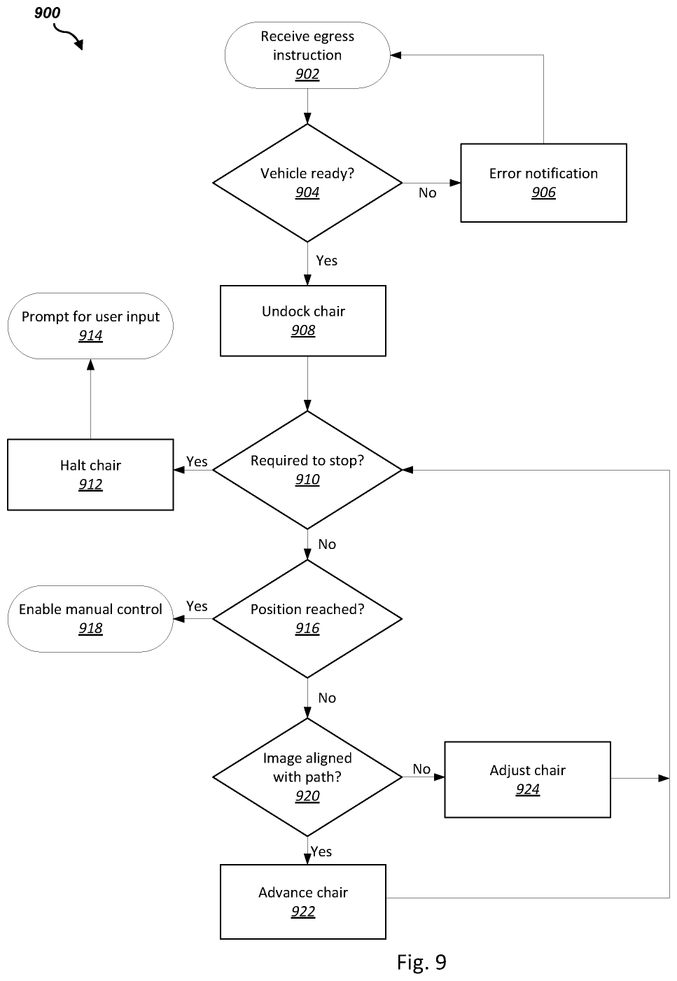

FIG. 9 is a flowchart illustrating a procedure 900 for automated undocking and egress from a vehicle 500. As above, for particular implementations, one or more of the automated steps may be substantially pre-programmed for use by the mobility device controller 120 or for instructions to the mobility device controller 120 from the vehicle 500 or a mobile device 200. Many of the steps of the egress procedure 900 are substantially the same as the steps of the automated vehicle navigation and docking procedure 800 described above, and will be understood to involve similar variations and techniques to those known in the art.

Upon receiving an egress instruction (step 902), the system may first confirm that the vehicle is ready (step 904), and provide an error notification if not (step 906). In some implementations, the same interface from which the egress instruction was provided, such as a mobile device 200 or vehicle interface, may provide an option along with the error notification to configure the vehicle 500 for egress, such as placing the vehicle 500 in park, opening the door 506, and deploying the access ramp 502. Any other readiness features controlled by the vehicle 500, such as hazard lights, seat configuration, or the vehicle's operational status, may also be confirmed before automated navigation is initialized. Where one or more control systems involved in this procedure have reason to believe that readying the vehicle 500 in park is not viable, such as detecting that the vehicle 500 is moving at speed rather than stopped or that there is insufficient clearance from the vehicle 500 to deploy the access ramp 502, then these features may be unavailable and not provided to a user.

The device 100 may be undocked in an analogous procedure to the earlier docking procedure. In some implementations, one or more of the undocking steps may require manual manipulation of the components as above. As an additional safeguard, the system may not carry out the egress procedure if one or more of the docking components are detected to still be locked or connected. This confirmation step may be performed before the procedure enters the control loop (steps 910 to 924) or may be a stop requirement as described with respect to step 910.

Upon entering an egress control loop, any of the step requirements described above with respect to step 810 may again be detected by the system (step 910). The mobility device 100 may then be halted, as described above (step 912), either immediately or after some further navigation control as needed under the circumstances. User input may be solicited, either controlled or general, in order remedy any detected issue with the egress procedure 900 or to allow for user control of the system (step 914).

The egress procedure 900 may, in some implementations, include a mechanism to sense proximity exterior to the vehicle 500 on the side where the access ramp 502 is deployed. One determination that may, in some cases, require a stop to the procedure is sensing an obstacle in proximity to that side of the vehicle that may not allow the mobility device 100 and passenger clearance to exit the ramp 502. The device 100 may need to be halted and/or reversed along the path in order to wait for or negotiate clearance outside the vehicle 500.

In some implementations, determining whether the device's destination position is yet reached (step 916) may coincide with the mobility device 100 being clear of the access ramp 502. The system may enable manual control as soon as the mobility device 100 has egressed the vehicle 500 so that the user can operate the mobility device 100 without further delay.

The control loop may continue navigating the path at any cycle in which there is no stop requirement and the position is not yet reached (“no” branch at decision blocks 910 and 916). Here, as above, the system may determine from the received images whether the mobility device 100 should advance (step 922) or adjust (step 924) based on its current alignment with the marked and/or determined path (step 920).

Exemplary embodiments described herein should not be considered limiting to the range of implementations available to one of ordinary skill in the art. For example, while described and shown as a vehicle access ramp, it will be recognized that motorized lift platforms are also known to provide access to motorized devices. While the mobility device is described and illustrated as a wheelchair, it will be recognized that a variety of mobility devices exist for which automated operations can be performed in conjunction with a vehicle. While described as a driver seat, it will be recognized that the automated procedures would also apply to docking to other positions in a vehicle, including passenger positions in any row. While the automobile shown resembles a minivan, it will be recognized that many vehicles of different sizes and operating parameters may be configured to allow for automated navigation and docking as described herein.

The data structures and code, in which the control systems of the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware components. For example, the hardware components can include, but are not limited to, application-specific integrated circuit (ASIC) chips, field-programmable gate arrays (FPGAs), and other programmable-logic devices now known or later developed. When the hardware components are activated, the hardware components perform the methods and processes included within the hardware components.

The technology described herein can be implemented as logical operations and/or components. The logical operations can be implemented as a sequence of processor-implemented executed blocks and as interconnected machine or circuit components. Likewise, the descriptions of various components can be provided in terms of operations executed or effected by the components. The resulting implementation is a matter of choice, dependent on the performance requirements of the underlying system implementing the described technology. Accordingly, the logical operations making up the embodiment of the technology described herein are referred to variously as operations, blocks, objects, or components. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method to automatically navigate a mobility device, comprising:
receiving real-time images of a vehicle;
determining the position and orientation of a mobility device relative to the vehicle based on the received real-time images;
automatically determining, based on the position and orientation of the mobility device, a control command for navigating the mobility device from its determined position to a destination position within the vehicle; and
providing the determined control command to cause the mobility device to move.

2. The computer-implemented method of claim 1, further comprising:
repeating the steps of claim 1 until the mobility device's position is determined to be the destination position.

3. The computer-implemented method of claim 1, wherein the destination position is a docking position.

4. The computer-implemented method of claim 3, further including the steps of:
determining that the mobility device is positioned at the docking position; and
automatically activating a mechanical locking system in order to lock the mobility device in the docking position within the vehicle.

5. The computer-implemented method of claim 4, further including the step of automatically activating an electrical connection between the mobility device and the vehicle.

6. The computer-implemented method of claim 1, wherein the vehicle includes an integrated accessibility feature such that the determined position of a vehicle is outside the vehicle and the mobility device is automatically navigated into the vehicle using the integrated accessibility feature.

7. The computer-implemented method of claim 6, wherein the accessibility feature is a deployable ramp.

8. The computer-implemented method of claim 1, wherein determining the position and orientation of the mobility device further comprises identifying one or more visual markings placed on the vehicle.

9. The computer-implemented method of claim 1, wherein the real-time images are received from a camera mounted on the mobility device.

10. The computer-implemented method of claim 1, wherein the real-time images are received from a mobile device.

11. The computer-implemented method of claim 1, wherein the steps of claim 1 are performed by a mobility device controller in response to receiving a user-initiated instruction from a mobile device.

12. The computer-implemented method of claim 11, further comprising:
receiving from the mobile device a user-initiated instruction; and
based on the user-initiated instruction, providing a control command to cause the mobility device to stop moving.

13. A computer-implemented method to automatically accommodate a mobility device, comprising:
receiving, at a control system associated with a vehicle, a signal from a mobility device outside the vehicle;
determining one or more vehicle operations necessary to configure the vehicle for automated docking by the mobility device;
executing the determined one or more vehicle operations on the associated vehicle;
subsequent to executing the determined one or more vehicle operations, determining a position of the mobility device within the vehicle; and
based on the mobility device's position within the vehicle, executing one or more further vehicle operations to accommodate the mobility device.

14. The computer-implemented method of claim 13, wherein the mobility device is a wheelchair, and wherein the one or more vehicle operations includes deploying a motorized ramp.

15. The computer-implemented method of claim 13, wherein the one or more further vehicle operations includes automatically activating a mechanical locking system to secure the mobility device in place within the vehicle.

16. The computer-implemented method of claim 13, further comprising:
prior to executing the determined one or more vehicle operations, determining a position of the mobility device outside the vehicle;
wherein determining the one or more vehicle operations is based on the determined position of the mobility device outside the vehicle.

17. An automated mobility device, comprising:
an arm configured to receive a mobile device;
a mobility device controller configured to provide a control command to cause the mobility device to move, wherein the mobility device controller is further configured to:
electronically connect to a mobile device received by the arm;
receive a signal from the mobile device; and
based on the received signal from the mobile device, provide a control command to cause the mobility device to move.

18. The automated mobility device of claim 17, wherein the mobility device controller is further configured to, in response to the received signal from the mobile device:
determine the position and orientation of the mobility device relative to a vehicle; and
automatically determine, based on the position and orientation of the mobility device, a control command for navigating the mobility device from its determined position to a destination position; and
wherein the determined control command is the control command provided based on the received signal from the mobile device.

19. The automated mobility device of claim 17, wherein the mobility device controller is further configured to:
receive a second signal from the mobile device;
based on the second signal, provide a control command to cause the mobility device to stop moving.

20. The automated mobility device of claim 19, wherein the received signal and the second signal from the mobile device were each sent in response to commands initiated by a user interacting with the mobile device.
